(19) United States
(12) Patent Application Publication
(10) Pub. No.: US 2007/0208730 A1
(43) Pub. Date: Sep. 6, 2007

(54) MINING WEB SEARCH USER BEHAVIOR TO ENHANCE WEB SEARCH RELEVANCE

(75) Inventors: Yevgeny E. Agichtein, Seattle, WA (US); Eric D. Brill, Redmond, WA (US); Susan T. Dumais, Kirkland, WA (US); Robert J. Ragno, Kirkland, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/457,733

(22) Filed: Jul. 14, 2006

Related U.S. Application Data
(60) Provisional application No. 60/778,650, filed on Mar. 2, 2006.

(51) Int. Cl. G06F 17/30

(52) U.S. Cl. 707/5

(57) ABSTRACT

Systems and methods that estimate user preference, via automatic interpretation of user behavior. A user behavior component associated with a search engine can automatically interpret collective behavior of users (e.g., web search users). Such feedback component can include user behavior features and predictive models (e.g., from a user behavior component) that are robust to noise, which can be present in observed user interactions with the search results (e.g., malicious and/or irrational user activity.)

### CROSS-REFERENCE TO RELATED APPLICATIONS

This is an application claiming benefit under 35 U.S.C. 119(e) of U.S. Provisional Patent Application Ser. No. 60/778,650 filed on Mar. 2, 2006. The entirety of this application is hereby incorporated herein by reference.

### BACKGROUND

Given the popularity of the World Wide Web and the Internet, users can acquire information relating to almost any topic from a large quantity of information sources. In order to find information, users generally apply various search engines to the task of information retrieval. Search engines allow users to find Web pages containing information or other material on the Internet that contain specific words or phrases.

In general, a keyword search can find, to the best of a computer's ability, all the Web sites that have any information in them related to any key words and phrases that are specified. A search engine site will have a box for users to enter keywords into and a button to press to start the search. Many search engines have tips about how to use keywords to search effectively. Typically, such tips aid users to narrowly define search terms, so that extraneous and unrelated information are not returned and the information retrieval process is not cluttered. Such manual narrowing of terms can mitigate receiving several thousand sites to sort through when looking for specific information.

In some cases, search topics are pre-arranged into topic and subtopic areas. For example, “Yahoo” provides a hierarchically arranged predetermined list of possible topics (e.g., business, government, science, etc.) wherein the user will select a topic and then further choose a subtopic within the list. Another example of predetermined lists of topics is common on desktop personal computer help utilities, wherein a list of help topics and related subtopics are provided to the user. While these predetermined hierarchies may be useful in some contexts, users often need to search for/inquire about information outside of and/or not included within these predetermined lists. Thus, search engines or other search systems are often employed to enable users to direct queries, to find desired information. Nonetheless, during user searches many unrelated results are retrieved, since users may be unsure of how to author or construct a particular query. Moreover, such systems commonly require users to continually modify queries, and refine retrieved search results to obtain a reasonable number of results to examine.

It is not uncommon to type in a word or phrase in a search system input query field, and then retrieve several million results as potential candidates. To make sense of the large number of retrieved candidates, the user will often experiment with other word combinations, to further narrow the list.

In general, the search system will rank the results according to predicted relevance of results for the query. The ranking is typically based on a function that combines many parameters including the similarity of a web page to a query as well as intrinsic quality of the document, often inferred from web topology information. The quality of the user's search experience is directly related to the quality of the ranking function, as the users typically do not view lower-ranked results.

In general, the search system will attempt to match or find all topics relating to the user's query input regardless of whether the “searched for” topics have any contextual relationship to the topical area or category of what the user is actually interested in. As an example, if a user who was interested in astronomy were to input the query “Saturn” into a conventional search system, all types of unrelated results are likely to returned including those relating to cars, car dealers, computer games, and other sites having the word “Saturn”. Another problem with conventional search implementations is that search engines operate the same for all users regardless of different user needs and circumstances. Thus, if two users enter the same search query they typically obtain the same results, regardless of their interests or characteristics, previous search history, current computing context (e.g., files opened), or environmental context (e.g., location, machine being used, time of day, day of week).

Tuning the search ranking functions to return relevant results at the top generally requires significant effort. A general approach for modern search engines is to train ranking functions and set function parameters and weights automatically based on examples of manually rated search results. Human annotators can explicitly rate a set of pages for a query according to perceived relevance, and creating the “gold standard” against which different ranking algorithms can be tuned and evaluated. However, explicit human ratings are expensive and difficult to obtain, often resulting in incompletely trained and suboptimal ranking functions.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

The subject innovation enhances search rankings in an information retrieval system, via employing a user behavior component that facilitates an automatic interpretation for the collective behavior of users, to estimate user preferences for one item over another item. Such preferences can then be employed for various purposes, such as to improve the ranking of the results. The user behavior component can interact with a search engine(s) and include feedback features that mitigate noise which typically accompany user behavior (e.g., malicious and/or irrational user activity.) By exploiting the aggregate behavior of users (e.g., not treating each user as an individual expert) the subject innovation can mitigate noise and generate relevance judgments from feedback of users. The user behavior component can employ implicit or explicit feedback from users and their interactions with results from previous queries. Key behavioral features include presentation features that can help a user determine whether a result is relevant by looking at the result title and description; browsing features like dwell time on a page, manner of reaching search results (e.g., thru other links) deviation from average time on domain, and the like; clickthrough features such as the number of clicks on a particular result for the query. For a given query-result pair the subject innovation provides multiple observed and derived feature values for each feature type.

The user behavior component can employ a data-driven model of user behavior. For example, the user behavior component can model user web search behavior as if it were generated by two components: a “background” component, (such as users clicking indiscriminately), and a “relevance” component, (such as query-specific behavior that is influenced by the relevance of the result to the query).

According to a further aspect of the subject innovation, the user behavior component can generate and/or model the deviations from the expected user behavior. Hence, derived features can be computed, wherein such derived features explicitly address the deviation of the observed feature value for a given search result from the expected values for a result, with no query-dependent information.

Moreover, the user behavior component of the subject innovation can employ models having two feature types for describing user behavior, namely: direct and deviational, where the former is the directly measured values, and latter is deviation from the expected values estimated from the overall (query-independent) distributions for the corresponding directly observed features. Accordingly, the observed value o of a feature f for a query q and result r, can be expressed as a mixture of two components:
o(q,r,j)=C(r,f)+rel(q,r,j)
where C(r, f) is the prior “background” distribution for values of aggregated across all queries corresponding to r, and rel(q, r, j) is the “relevance” component of the behavior influenced by the relevance of the result to the query. For example, an estimation of relevance of the user behavior can be obtained with clickthrough feature, via a subtraction of background distribution from the observed clickthrough frequency at a given position. To mitigate the effect of individual user variations in behavior, the subject innovation can average feature values across all users and search sessions for each query-result pair. Such aggregation can supply additional robustness, wherein individual “noisy” user interactions are not relied upon.

Accordingly, the user behavior for a query-result pair can be represented by a feature vector that includes both the directly observed features and the derived, “corrected” feature values. Various machine learning techniques can also be employed in conjunction with training ranking algorithms for information retrieval systems. For example, explicit human relevance judgments can initially be provided for various search queries and employed for subsequent training ranking algorithms.

In a related aspect, collective behavior of users interacting with a web search engine can be automatically interpreted in order to predict future user preferences; hence, the system can adapt to changing user behavior patterns and different search settings by automatically retraining the system with the most recent user behavior data.

To the accomplishment of the foregoing and related ends, certain illustrative aspects of the claimed subject matter are described herein in connection with the following description and the annexed drawings. These aspects are indicative of various ways in which the subject matter can be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a block diagram of a user behavior component in accordance with an exemplary aspect of the subject innovation.

FIG. 2 illustrates a block diagram of a system that incorporates a user behavior component and interacts with a training model of a search engine in accordance with an aspect of the subject innovation.

FIG. 3 illustrates a block diagram of a system that incorporates a ranker component operatively connected to a user behavior component, and a search engine in accordance with an exemplary aspect of the subject innovation.

FIG. 4 illustrates a table of features that represent user browsing activities in accordance with an aspect of the subject innovation.

FIG. 5 illustrates an automated information retrieval system that can employ a machine learning component in accordance with an aspect of the subject innovation.

FIG. 6 illustrates a user behavior component that interacts with a plurality of system features, which represent user action according to a particular aspect of the subject innovation.

FIG. 7 illustrates an exemplary methodology of interpreting user behavior to estimate user preferences in accordance with an aspect of the subject innovation.

FIG. 8 illustrates a methodology of implementing user behavior as part of value ranking in accordance with an aspect of the subject innovation.

FIG. 9 illustrates an exemplary environment for implementing various aspects of the subject innovation.

FIG. 10 is a schematic block diagram of an additional-computing environment that can be employed to implement various aspects of the subject innovation.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used herein, the terms “component,” “system”, “feature” and the like are also intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term computer program as used herein is intended to encompass a computer program accessible from any computer-readable device, carrier, or media. For example, computer readable media can include but are not limited to magnetic storage devices (e.g., hard disk, floppy disk, magnetic strips . . . optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the claimed subject matter.

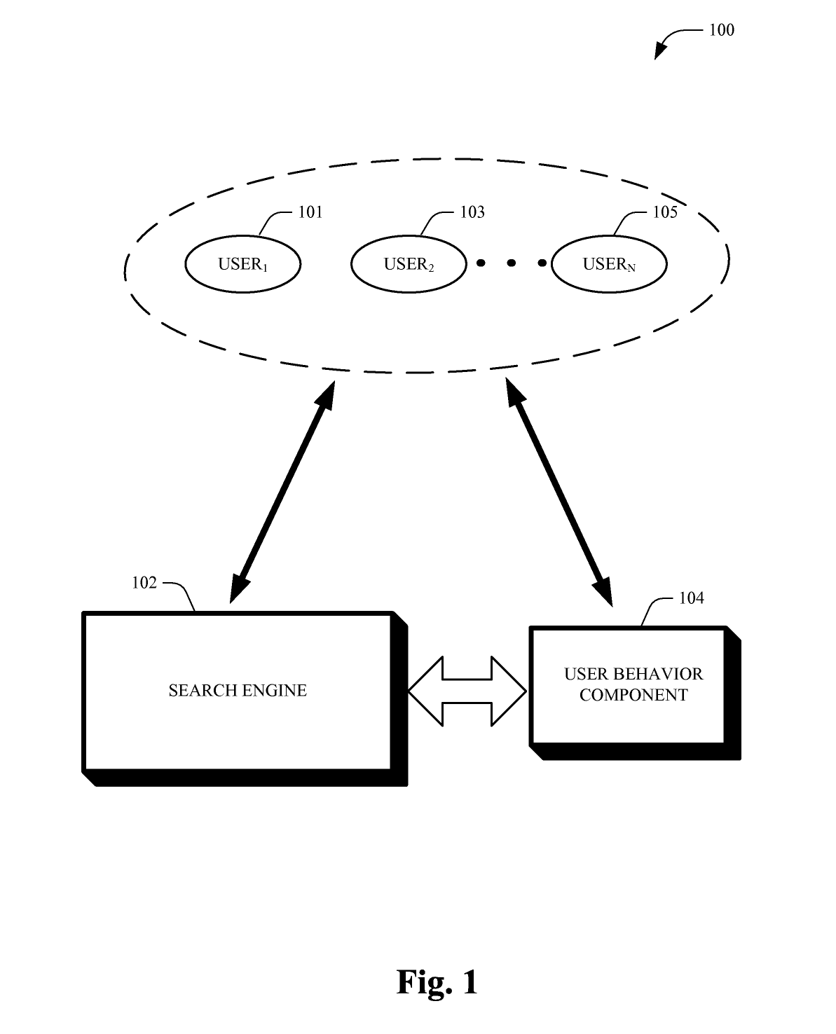

Turning initially to FIG. 1, a block diagram of a system 100 is illustrated, which incorporates a user behavior component that interacts with a search engine in accordance with an exemplary aspect of the subject innovation. The user behavior component 104 associated with the search engine 102 can automatically interpret collective behavior of users 101, 103, 105 (1 to N, where N is an integer). Such user behavior component 104 can include feedback features that mitigate noise, which typically accompany user behavior (e.g., malicious and/or irrational user activity.) By exploiting the aggregate behavior of the users 101, 103, 105 (e.g., not treating each user as an individual expert) the system 100 can mitigate noise, and generate relevance judgments from feedback of users.

The user behavior component 104 can interact with the ranking component. For a given query the user behavior component 104 retrieves the predictions derived from a previously trained behavior model for this query, and reorders the results for the query such that results that appeared relevant for previous users are ranked higher. For example for a given query q, the implicit score ISᵣ can be computed for each result r from available user interaction features, resulting in the implicit rank Iᵣ for each result. A merged score SM(r) can be computed for r by combining the ranks obtained from implicit feedback, Iᵣ with the original rank of r, Oᵣ:

$$SM ( r , {I}_{r} , {O}_{r} , {w}_{l} ) = \{ \begin{matrix}{w}_{l} \frac{1}{{I}_{r} + 1} + \frac{1}{{O}_{r} + 1} & if implicit feedback exists for r \\ \frac{1}{{O}_{r} + 1} & otherwise\end{matrix}$$

The weight w_{I} is a heuristically tuned scaling factor that represents the relative “importance” of the implicit feedback. The query results can be ordered in by decreasing values of SM(r) to produce the final ranking. One particular case of such model arises when setting w_{I} to a very large value, effectively forcing clicked results to be ranked higher than unclicked results—an intuitive and effective heuristic that can be employed as a baseline. In general, the approach above assumes that there are no interactions between the underlying features producing the original web search ranking and the implicit feedback features. Other aspects of the subject innovation relax such assumption by integrating the implicit feedback features directly into the ranking process, as described in detail infra. Moreover, it is to be appreciated that more sophisticated user behavior and ranker combination algorithms can be employed, and are well within the realm of the subject innovation.

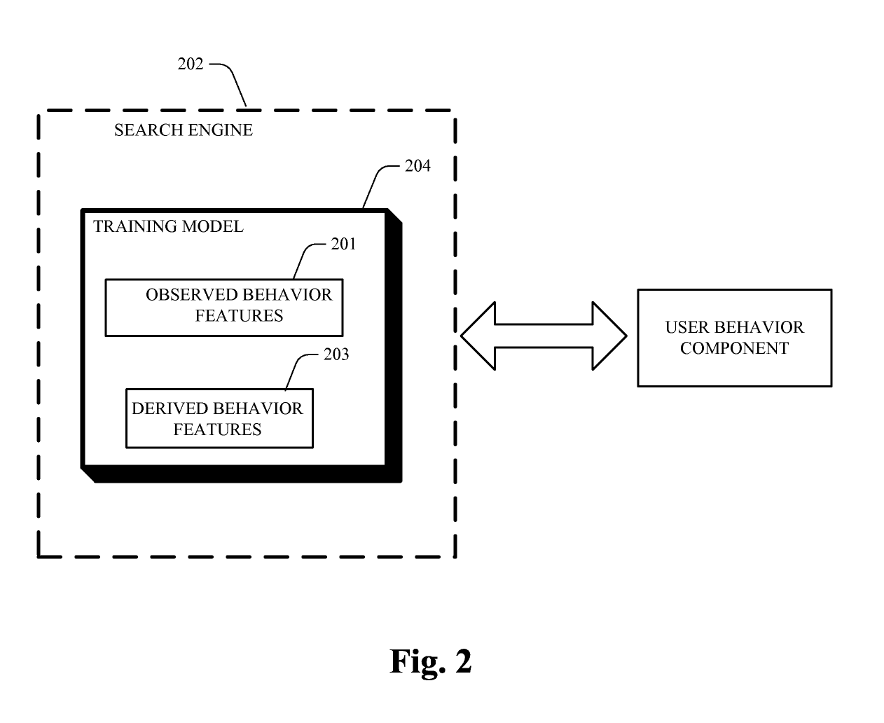

FIG. 2 illustrates a further aspect of the subject innovation, wherein the search engine 202 further comprises a training model 204 in accordance with an aspect of the subject innovation. The training model 204 can further comprise additional models types for describing user behavior, namely: an observed behavior feature 201 and a derived behavior feature 203. The observed behavior features 201 is the directly measured values, and the derived behavior feature 203 is deviation from the expected values estimated from the overall (query-independent) distributions for the corresponding directly observed features. Accordingly, the observed value o of a feature f for a query q and result r, can be expressed as a mixture of two components:
o(q,r,j)=C(r,j)+rel(q,r,f)
where C(r, f) is the prior “background” distribution for values off aggregated across all queries corresponding to r, and rel(q, r, j) is the component of the behavior influenced by the relevance of the results. For example, an estimation of relevance of the user behavior can be obtained with clickthrough feature, via a subtraction of background distribution (e.g., noise) from the observed clickthrough frequency at a given position. To mitigate the effect of individual user variations in behavior, the subject innovation can average direct feature values across all users and search sessions for each query-URL pair. Such aggregation can supply additional robustness, wherein individual “noisy” user interactions are not relied upon. Accordingly, the user behavior for a query-URL pair can be represented by a feature vector that includes both the directly observed features and the derived, “corrected” feature values.

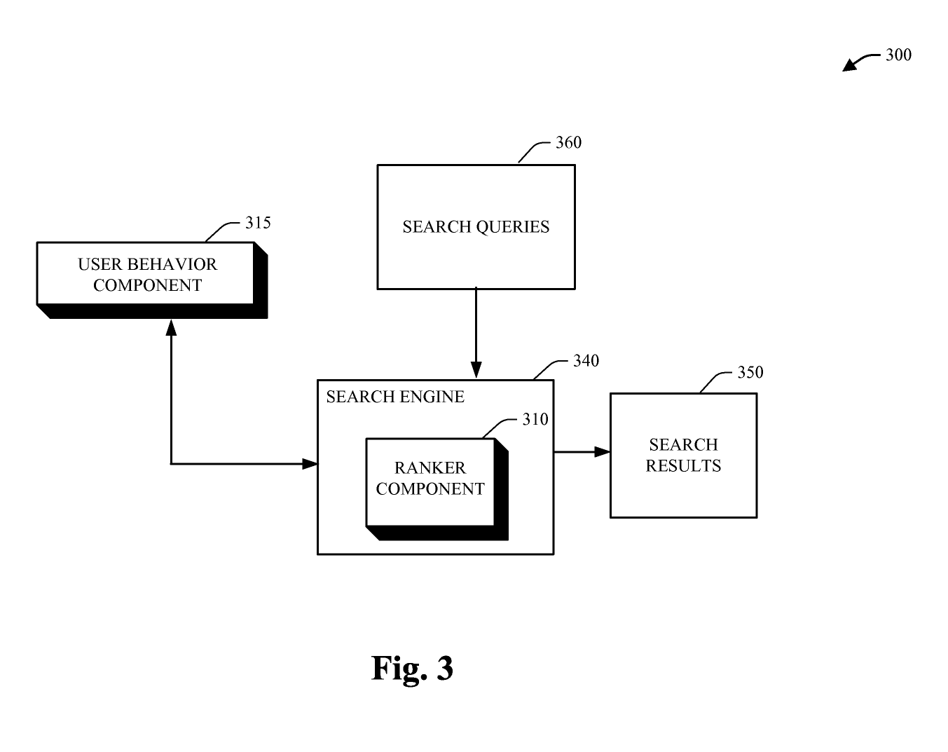

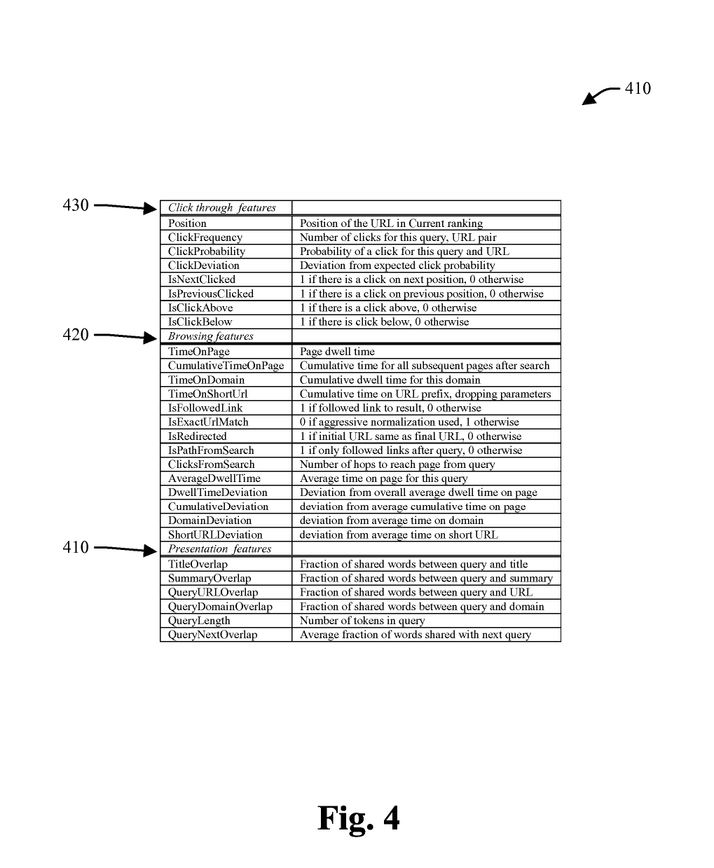

FIG. 3 illustrates a block diagram of a system 300 that incorporates a ranker component 310 operatively connected to a user behavior component 315 and a search engine 340 in accordance with an exemplary aspect of the subject innovation. Typically, the search engine 340 can rank search results 350 based on a large number of features, including content-based features (e.g., how closely a query matches the text or title or anchor text of the document), and query independent page quality features (e.g., PageRank of the document or the domain), as described in detail infra. Moreover, the search engine 340 can employ automatic (or semi-automatic) methods for tuning the specific ranking function that combines such feature values. For example, it can be assumed that a user who submits a query 360 will perform particular actions. Such actions can include clicking, navigating, submitting query refinements until finding a relevant document, and the like. Upon finding the relevant document, the user can become satisfied and change behavior (e.g., to read the document). The subject innovation enables devising a sufficiently rich set of features that would allow detection of when the user is satisfied with a result retrieved. Such features are dependent on queries submitted, and hence are query specific. For example, user features/activities can be categorized into presentation features, browsing features, and clickthrough features, as described with reference to FIG. 4.

FIG. 4 illustrates a table of features 400 that represent user browsing activities. The presentation features 410 are typically designed to represent the experience of the user as they affect some or all aspects of the behavior (e.g., a user may decide to click on a result based on the presentation features). To model such aspect of user experience the subject innovation can employ features such as overlap in words in title and words in query (TitleOverlap) and the fraction of words shared by the query and the result summary, as these are often considered by users when making a decision whether to click on a result summary to view the complete document.

Likewise, the browsing feature 420 can capture and quantify aspects of the user web page interactions. For example, the subject innovation can compute deviation of dwell time from expected page dwell time for a query, which allows for modeling intra-query diversity of page browsing behavior. Such can further include both the direct features and the derived features, as described in detail supra. Likewise, clickthrough features 430 are an example of user interaction with the search engine results. For example, clickthrough features can include the number of clicks for a query-result pair, or the deviation from the expected click probability.

As illustrated in FIG. 4, clickthrough illustrates one aspect of user interactions with a web search engine. The subject innovation can employ automatically derived predictive user behavior models. Accordingly, for a given query, each result can be represented with the features in Table of FIG. 4. Relative user preferences can then be estimated using the learned user behavior model, as described in detail above. The use of such user behavior models enables the search engine to benefit from the wisdom of crowds interacting with the search results as well as richer features characterizing browsing behavior beyond the search results page.

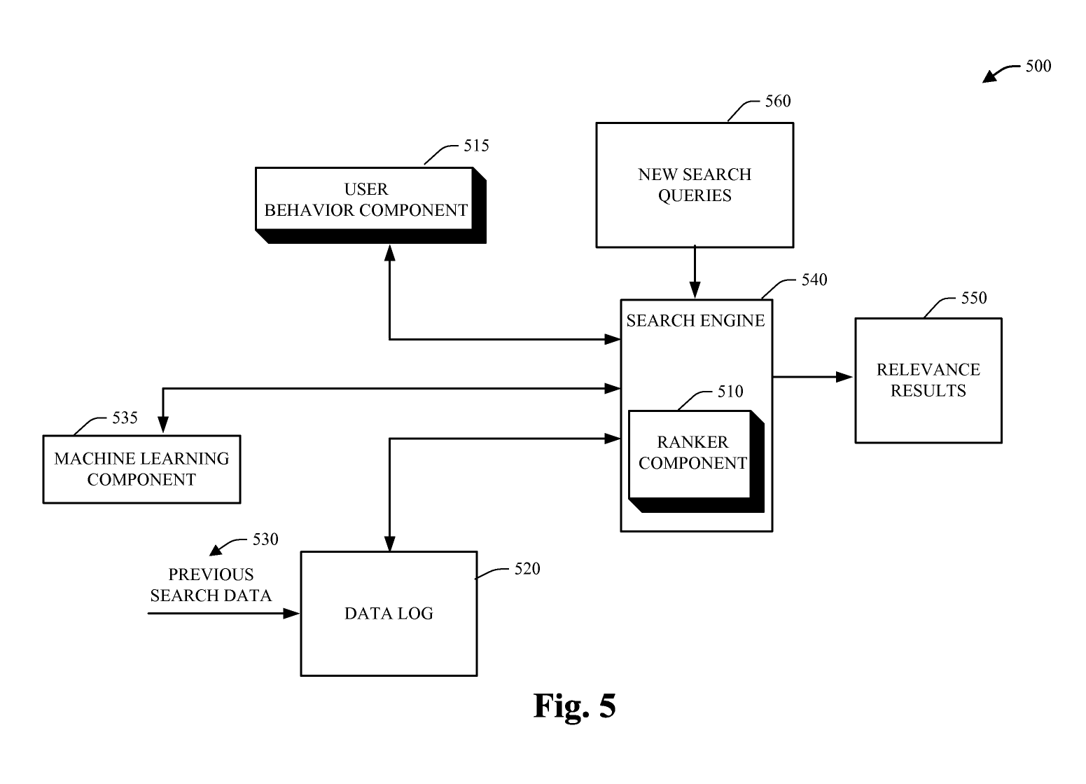

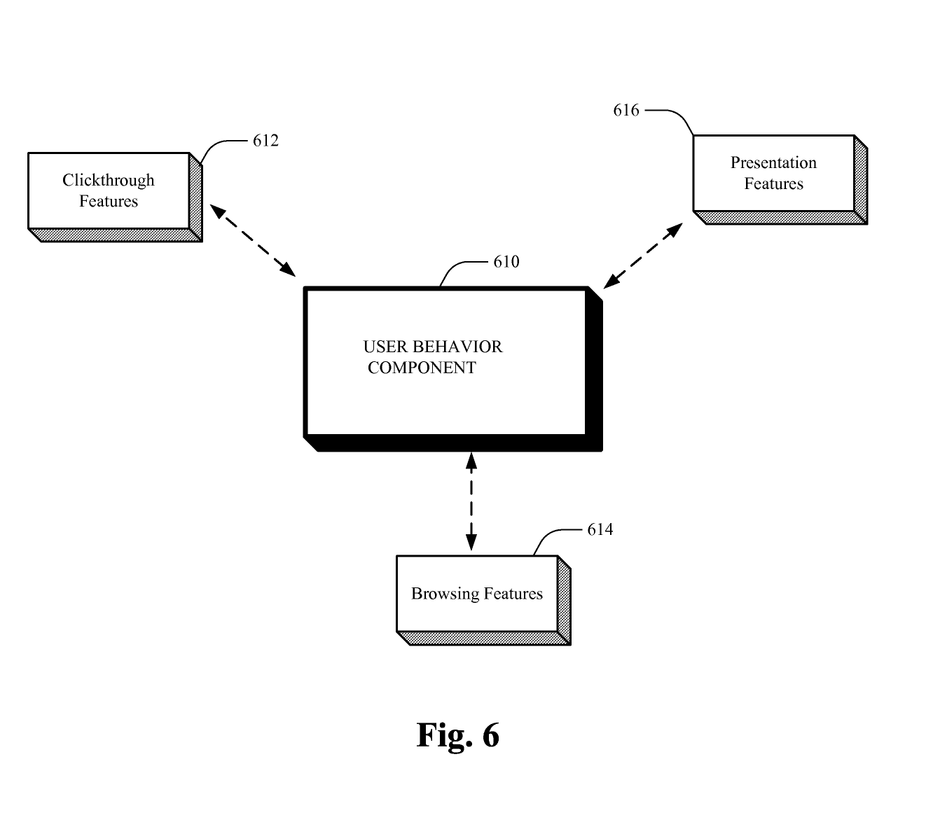

FIG. 5 illustrates an automated information retrieval system 500 that can employ a machine learning component 535 in accordance with an aspect of the subject innovation. A general implicit feedback interpretation strategy can be employed to automatically learn a model of user preferences (e.g., instead of relying on heuristic or insights). The system 500 includes a ranking component 510 that can be trained from a data log 520 or interactions with the user behavior component 515, for example. Data in the log 520 can be gathered from local or remote data sources and includes information relating to previous search data or activities 530 from a plurality of users. After training, the ranker component 510 can interact with the search engine 540 to facilitate or enhance future search results that are indicated as relevant results 550. For example, one or more new search queries 560 can be processed by the search engine 540, based in part on training from the previous search data 530, and/or information from the user behavior component 515. In general, the system 500 can employ various data mining techniques for improving search engine relevance. Such can include employing relevance classifiers in the ranker component 510, to generate high quality training data for runtime classifiers, which are employed with the search engine 540 to generate the search results 550. FIG. 6 illustrates a user behavior component 610 that interacts with a plurality of system features, which represent user action. In one aspect, the subject innovation considers web search behaviors as a combination of a “background” component (e.g., query- and relevance-independent noise in user behavior, and the like), and a “relevance” component (e.g., query-specific behavior indicative of the relevance of a result to a query). Such an arrangement can take advantage of aggregated user behavior, wherein the feature set is comprised of directly observed features (computed directly from observations for each query), as well as query-specific derived features, computed as the deviation from the overall query-independent distribution of values for the corresponding directly observed feature values. As illustrated in FIG. 6, exemplary system features such as: clickthrough feature(s) 612, browsing feature(s) 614, and presentation features 616, which can be employed to represent user interactions with web search results, thru the user behavior component 610. Moreover, features such as the deviation of the observed clickthrough number for a given query-URL pair from the expected number of clicks on a result in the given position, can also be considered. Moreover, the browsing behavior can be modeled, e.g., after a result is clicked, then the average page dwell time for a given query-URL pair, as well as its deviation from the expected (average) dwell time, is employed for such model. Additionally, example, web search users can often determine whether a result is relevant by looking at the result title, URL, and summary—in many cases, looking at the original document is typically not necessary. To model this aspect of user experience, features such as: overlap in words in title and words in query, can also be employed.

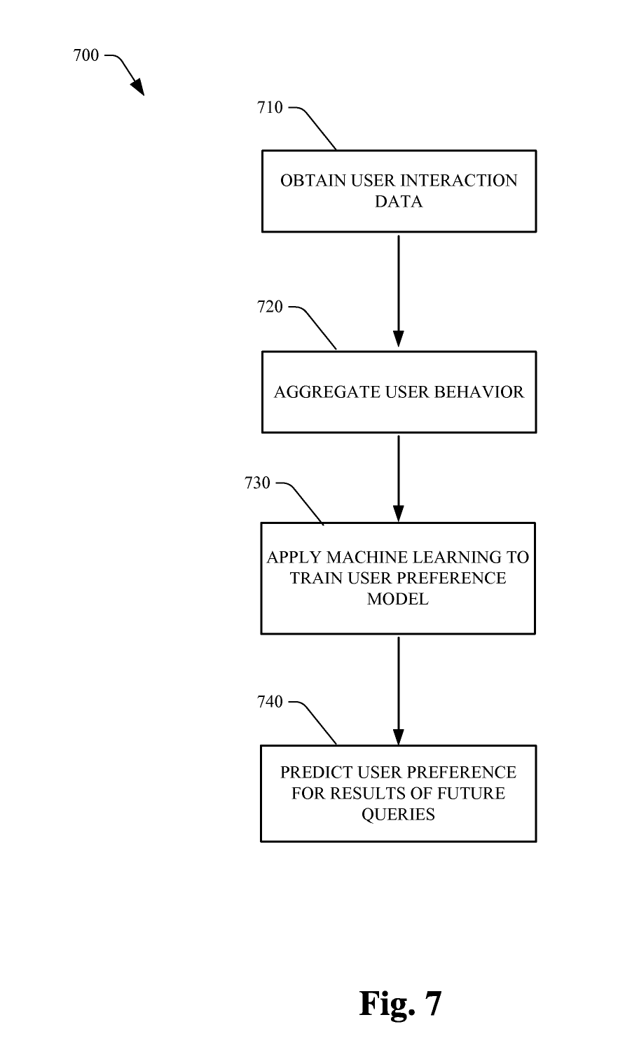

FIG. 7 illustrates an exemplary methodology 700 of interpreting user behavior to estimate user preferences in accordance with an aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described. Initially and at 710, data related to user interaction with the search engine, such as post search user behavior can be acquired. Subsequently and at 720, user behavior can be aggregated, for example by employing statistical analysis techniques. At 730, machine learning can then be employed to train user preference model. Subsequently, and at 740 user preference predictions can be supplied for result of future queries.

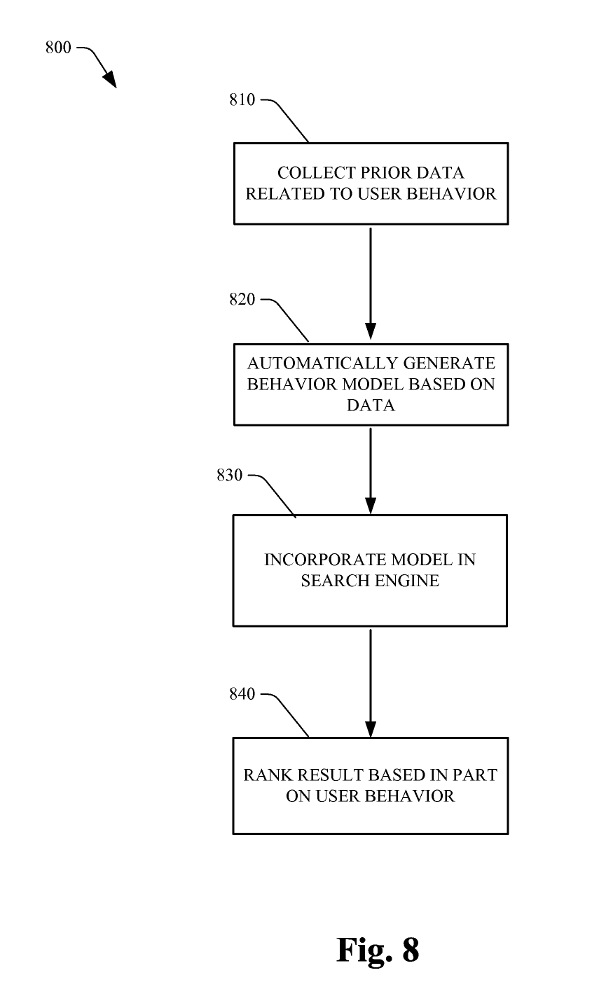

FIG. 8 illustrates a methodology 800 of implementing user behavior as part of ranking in accordance with an aspect of the subject innovation. Initially, and at 810, data related to user behavior can be collected. Such user behavior can then be employed to train and/or automatically generate a behavior model at 820. Such model (e.g., predictive behavior model) can then be incorporated as part of a search engine to rank results and/or generate implicit relevance judgments from the feedback of users, at 830. Subsequently, and 840 based in part on the generated and/or trained behavioral model information retrieved by the search engine can then be ranked.

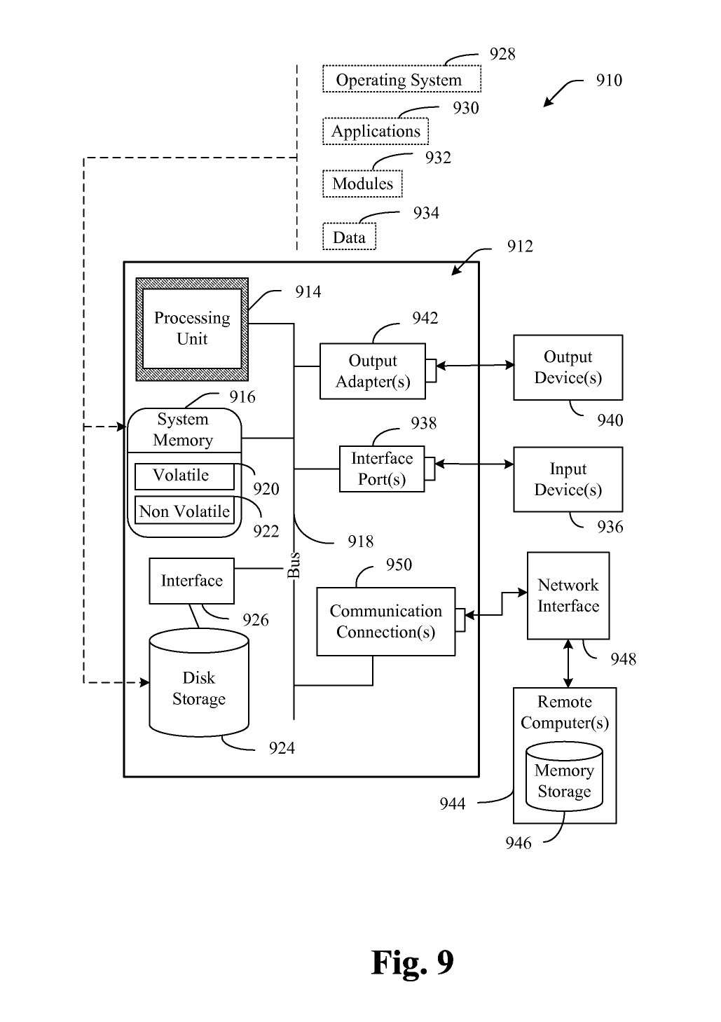

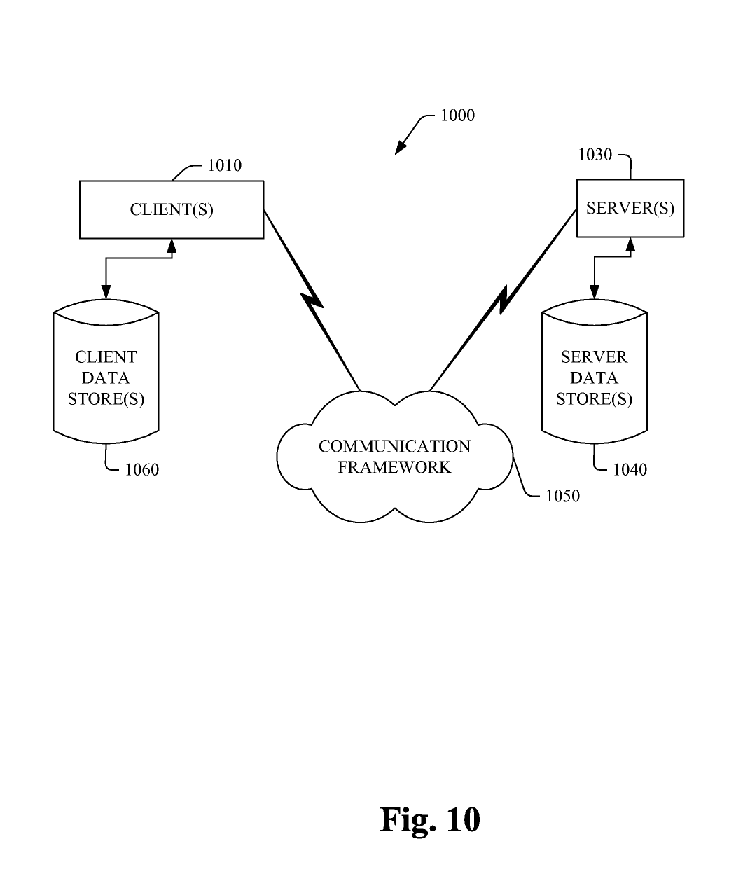

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, etc. that perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

With reference to FIG. 9, an exemplary environment 910 for implementing various aspects of the subject innovation is described that includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates, for example a disk storage 924. Disk storage 924 includes, but is not limited to, devices like a magnetic disk drive, floppy disk drive, tape drive, Jaz drive, Zip drive, LS-60 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers. The word “exemplary” is used herein to mean serving as an example, instance, or illustration. Any aspect or design described herein as “exemplary” is not necessarily to be construed as preferred or advantageous over other aspects or designs.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term computer program as used herein is intended to encompass a computer program accessible from any computer-readable device, carrier, or media. For example, computer readable media can include but are not limited to magnetic storage devices (e.g., hard disk, floppy disk, magnetic strips . . . optical disks (e.g., compact disk (CD), digital versatile disk (DVD). . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the claimed subject matter.

FIG. 10 is a schematic block diagram of a sample-computing environment 1000 that can be employed for estimating user preference via user behavior component in accordance with an aspect of the subject innovation. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operably connected to one or more client data store(s) 1060 that can be employed to store information local to the client(s) 1010. Similarly, the server(s) 1030 are operably connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system comprising the following computer-executable components:
a user behavior component that facilitates automatic interpretation of collective behavior of users, to estimate user preferences of search results; and
a search engine that incorporates the collective behavior for determination of relevance and ranking of returned search results.

2. The computer implemented system of claim 1, the user behavior component further comprises a background component and a relevance component.

3. The computer implemented system of claim 1 further comprising a machine learning component.

4. The computer implemented system of claim 1, the user behavior component further comprising a data driven model of user behavior.

5. The computer implemented system of claim 4, the search engine further comprising a user behavior model with directly observed features and derived behavior features.

6. The computer implemented system of claim 4 further comprising a data log that includes prior search data.

7. The computer implemented system of claim 1, the search engine further comprising a ranker component that ranks search results.

8. The computer implemented system of claim 5 further comprising a machine learning component that trains the user behavior model.

9. The computer implemented system of claim 5 the model further comprising clickthrough features, presentation features and browsing features.

10. A computer implemented method comprising the following computer executable acts:
obtaining user behavior during interaction with a search engine;
aggregating user behavior for an analysis thereof, and estimating user preferences for retrieved results.

11. The computer implemented method of claim 10 further comprising ranking retrieved information based on user preferences.

12. The computer implemented method of claim 10 further comprising training a model for ranking the information.

13. The computer implemented method of claim 10 further comprising automatically generating the model from user behavior.

14. The computer implemented method of claim 10 further comprising devising a set of features related to user interaction with information retrieved.

15. The computer implemented method of claim 10 further comprising employing machine learning to incorporate user behavior.

16. The computer implemented method of claim 10 further comprising predicting user behavior.

17. The computer implemented method of claim 10 further comprising mining aggregated user behavior for ranking of search results.

18. The computer implemented method of claim 10 further comprising employing directly observed features from user interactions with search results to estimate user preferences.

19. The computer implemented method of claim 10 further comprising mitigating noise associated with aggregate user behavior.

20. A computer implemented system comprising the following computer executable components:
means for collecting implicit feedback from users; and
means for estimating user preferences.
